(19) United States
(12) Patent Application Publication
(10) Pub. No.: US 2015/0319253 A1
(43) Pub. Date: Nov. 5, 2015

(54) Service platform for ubiquitous network and service implementation method

(71) Applicant: ZTE Corporation, Shenzhen, Guangdong (CN)

(72) Inventor: Aifang Sun, Shenzhen (CN)

(21) Appl. No.: 14/410,245

(22) PCT Filed: Jun. 26, 2013
(86) PCT No.: PCT/CN2013/078075

§ 371 Date: Dec. 22, 2014

(30) Foreign Application Priority Data
Jul. 3, 2012 (CN) 201210227618.2

(51) Int. Cl. H04L 29/08; H04L 12/911; H04L 12/24

(52) U.S. Cl. CPC H04L 67/16; H04L 41/5025; H04L 47/70

(57) ABSTRACT

A service platform for a ubiquitous network includes an application layer interface, a function implementation layer, a data processing layer, and a resource access layer. The application layer interface is configured to provide universal capability and support for a service application, and to provide a unified open interface to perform dynamic adaptation according to a user's requirement for a service. The function implementation layer is configured to implement cooperative service download and to directly provide the service for the user. The data processing layer is configured to directly perform data processing on the service for the user and to perform data processing for multiple terminals to cooperatively perform the service download. The resource access layer is configured to access network resources. A service implementation method in a ubiquitous-network based service platform is also provided.

### TECHNICAL FIELD

The disclosure relates to ubiquitous network communication techniques, and particularly relates to a service platform for the ubiquitous network and a service implementation method.

### BACKGROUND

In a ubiquitous cooperative network environment, multiple kinds of heterogeneous networks coexist for a long time and form different network forms in different organization ways, so that terminal heterogeneity and network heterogeneity problems become more complex. Various ubiquitous network oriented application services cannot implement effective compatibility with multiple kinds of heterogeneous networks. Providing dynamically adaptive services for industry applications and users to meet service requirements of the users, gradually becomes a key problem to be solved by the ubiquitous network. At the same time, in a ubiquitous network environment, a user peripheral environment is diversified increasingly; making full use of the user peripheral environment terminal to cooperatively serve the user can not only implement heterogeneous network convergence but also make full use of frequency bands and increase system throughput. How to use the diversified user peripheral environment to perform cooperation, also gradually becomes one of the key problems to be solved by the ubiquitous network.

Recently, in order to solve the heterogeneous network convergence problem, some standards organizations of the international telecommunication field and famous industrial organization begin to actively research a middleware related technical system, including Information Communication Architecture (ICA) by International Telecommunication Union Telecommunication Standardization Sector (ITU-T), open network API-Parlay by Parlay Group/ETST/3GPP, and etc. In all the organizations, some focus on research of theory and architecture, such as ICA; some focus on research of industrial practice, such as open network API.

In an EPC electronic label standardization aspect, the United States, as a global leader, establishes an Electronic Product Code Global Association (EPCGlobal). The EPCGlobal mainly performs research of Radio Frequency Identification (RFID) encoding and application development specification, a main responsibility of which is to establish and maintain in the world an Evolved Packet Core (EPC) network for various industries, and guarantee each link of a supply chain to adopt a global standard to automatically identify information in real time. The EPC technical specification includes label encoding specification, radio frequency label logic communication interface specification, reader reference implementation, Savant middleware specification, ONS object name resolution service specification, PML language, and etc.

According to a current research result, it still cannot solve problems in network convergence quite well.

### SUMMARY

In view of this, embodiments of the disclosure provide a service platform for a ubiquitous network and a service implementation method, which can provide service for the user based on the service platform for the ubiquitous network, so as to implement the service based on a convergence network.

In an embodiment, a service platform for a ubiquitous network is provided, which includes: an application layer interface, a function implementation layer, a data processing layer, and a resource access layer. The application layer interface is configured to provide universal capability and support for a service application, and to provide a unified open interface to perform dynamic adaptation according to a user's requirement for a service. The function implementation layer is configured to implement cooperative service download and to directly provide the service for the user. The data processing layer is configured to directly perform data processing on the service for the user and to perform data processing for multiple terminals to cooperatively perform the service download. The resource access layer is configured to access network resources.

Preferably, the function implementation layer implements at least one of the following functions for directly providing the service for the user: terminal management, capability engine, context service engine, service provision and adaption, service aggregation and reconstruction, and service authentication; and the function implementation layer implements at least one of the following functions for implementing the cooperative service download: initialization, service requirement processing, resource discovery, context obtaining and processing, aggregation and reconstruction control, an event notification element, security privacy management, configuration management, distributed information processing, information strategy library, and multi-interface enabling.

Preferably, the data processing layer directly performs at least one of the following data processings on the service for the user: data sharing, service engine, shunting, dynamic adaptation, parsing and management; and the data processing layer directly performs at least one of the following data processings for multiple terminals to cooperatively perform the service download: data aggregation and reconstruction, information collection, convergence, storage, parsing and management.

Preferably, the resource access layer accesses at least one of the following network resources: resources in a network layer, terminal devices in a perception extension layer and sub-network capability resources.

Preferably, the network resources includes: at least one of the following resource information in the network layer of the ubiquitous network: terminal or device information, service information, and radio resource information; and at least one of the following resource information in the perception extension layer: terminal or device information, and service information.

In an embodiment, a service implementation method in a ubiquitous-network based service platform is provided, which includes: when the service platform receives a service request, performing terminal management, capability engine, context service engine, service provision and adaption, service aggregation and reconstruction, so as to provide an application service meeting a user's personalized requirement for the use.

Preferably, the terminal management includes: performing unified management on ubiquitous network devices, performing local maintenance and remote management on the ubiquitous network devices and a network composed of the ubiquitous network devices, and supporting user remote self-service management and update services.

Preferably, the capability engine includes: abstracting the ubiquitous network devices as specific capabilities or resources, abstracting service environments that can be provided by heterogeneous networks as the specific capabilities, describing the capabilities in a universal mathematical description language, and providing support for service adaption and personalized services.

Preferably, the context service engine includes: dynamically obtaining context information of device capability, network feature, user preference and service content from a terminal side, a network side, a user side, an application side by means of context perception, and storing and processing the context information under a predefined rule.

Preferably, the service provision and adaption includes: implementing dynamic intelligent service discovery, service selection, service aggregation and service adaption function, according to obtained context information, uniformly detecting and collecting the ubiquitous network, heterogeneous network environment and terminal environment state, tracking and feeding back changes of a user service environment in real time, performing service negotiation and adaption, and dynamically cooperating the capabilities of the network and devices to guarantee a ubiquitous service quality, according to a service adaption result.

Preferably, the service aggregation and reconstruction includes: adapting and combining service streams or sub-services from different heterogeneous networks to form user-required service provision, and reconstructing a service process to provide an optimal service configuration process to the user.

In the disclosure, when receiving a service request, the service platform performs terminal management, capability engine, context service engine, service provision and adaption, service aggregation and reconstruction, thus providing the application service meeting the user's personalized requirement for the user. The service platform of the disclosure provides a unified platform which orients heterogeneous network convergence and heterogeneous device access, provides some universal capabilities and supports for ubiquitous network applications, and provides an open interface, enabling the service applications to access and use the network resources and capabilities; can implement aggregation and reconstruction of abstract resources and capabilities, dynamic intelligent service discovery, adaption and aggregation according to the context information such as service requirement, user preference, network feature, and etc., implement various application services meeting the user's personalized requirement; and at the same time, a basis is created for supporting ubiquitous service provision and implementing terminal cooperation and sub-network capability cooperation.

### BRIEF DESCRIPTION OF THE DRAWINGS

FIG. 1 is a schematic view of a ubiquitous network architecture according to an embodiment of the disclosure;

FIG. 2 is a schematic view of a structure of a ubiquitous-network-based service platform according to an embodiment of the disclosure;

FIG. 3 is a flowchart of a service implementation method in the ubiquitous-network-based service platform according to an embodiment of the disclosure; and

FIG. 4 is a flowchart of a service implementation method in the ubiquitous-network-based service platform according to another embodiment of the disclosure.

### DETAILED DESCRIPTION

In order to make the purpose, technical scheme and advantage of the disclosure more clear and explicit, the disclosure will be further explained in detail below by illustrating the embodiments with reference to appended drawings.

FIG. 1 is schematic view of a ubiquitous network architecture according to an embodiment of the disclosure. As shown in FIG. 1, the ubiquitous network in this embodiment includes a service application, a service platform architecture and a network resource part;

The service application may be provided for a service requirement dynamically adapted for an industry user, and may also be two parts for information interaction, provided to meet the user's service requirement, for cooperation of multiple kinds of ubiquitous terminals or sub-networks.

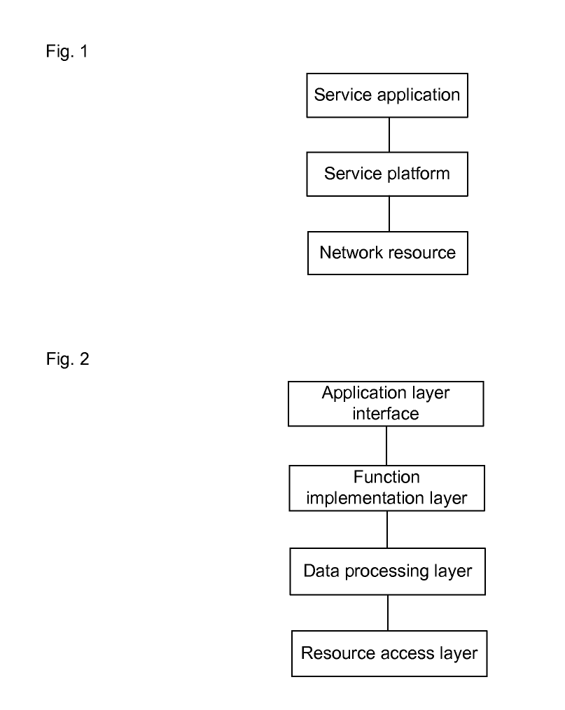

The specific structure and function of the service platform will be described in detail with reference to FIG. 2, and is not described in detail here.

The network resource includes but is not limited to terminal or device information, service information, radio resource information in a network layer of the ubiquitous network; and includes but is not limited to terminal or device information, service information in a perception extension layer. Definition of the network layer and the perception extension layer is known to the skilled in the art, details of which are not described here.

FIG. 2 is a schematic view of a structure of a ubiquitous-network-based service platform according to an embodiment of the disclosure. As shown in FIG. 2, the ubiquitous-network-based service platform according to the embodiment of the disclosure includes an application layer interface, a function implementation layer, a data processing layer, a resource access layer.

The application layer interface is an interface providing some universal capabilities and supports for an application, and is provided as a unified open interface; the format of the interface may be but not limited to be provided by a service platform provider, or may also be provided through negotiation between the service platform provider and a service user; the interface may be dynamically adapted to different requirements of the user to the service.

Functions provided by the function implementation layer include two parts, namely the function directly providing service for the user and the function implemented for terminal and sub-network capability cooperation.

The function implementation part directly providing the service for the user includes but is not limited to terminal management, capability engine, context service engine, service provision and adaption, service aggregation and reconstruction, service authentication.

The terminal management supports heterogeneous-ubiquitous-device oriented unified management, implements local maintenance and remote management of the ubiquitous devices and a network composed of the ubiquitous devices, and supports user remote self-service management and update service. Through a unified management platform, a terminal device provider may publish newer device software packages and configuration parameters. The management includes abstraction of device capability and location of device resource, implements related functions such as registration and authentication of the devices, and provides the context service engine with terminal information and capability description information.

The capability engine abstracts the ubiquitous device as a specific capability or resource, abstracts a service environment being able to be provided by a heterogeneous network as the specific capability, describes the capabilities in a universal mathematical description language, and provides support for service adaption and personalized services.

The context service engine is able to dynamically obtain the context information of device capability, the network feature, user preference and service content from a terminal side, a network side, a user side and an application side by using a context perception technique, and stores and simply processes the context information in accordance with a certain rule.

The service provision and adaption can implement functions related to such as dynamic intelligent service discovery, service selection, service aggregation and service adaption and etc. according to the context information obtained from the context service engine; can uniformly detect and collect ubiquitous heterogeneous network environment and terminal environment states, and can track and feedback changes of the user service environment in real time, thereby performing service negotiation and adaption processing; and can dynamically cooperate capability of the network and the device according to a service adaption result to guarantee ubiquitous service quality.

The service aggregation and reconstruction adapts and combines service streams or sub-services from different heterogeneous networks, forms user required services, and reconstructs a service process, and provides an optimum service configuration process to an upper layer user.

The function implemented for terminal and sub-network capability cooperation includes functions such as service platform initialization, service requirement processing, resource discovery, context obtain and processing, aggregation and reconstruction control, event notification, security privacy management, configuration management, distributed information processing and multiple-interface enabling.

The service requirement treatment means receiving user requirement and generating the service requirement for the user, integrating user preference and context information, mapping the user oriented requirement description to the service oriented requirement description, or receiving the service oriented requirement description sent by another device. This module performs corresponding treatment based on the requirement description, interacts with the modules such as the resource discovery module, the aggregation control module, the configuration management module, and the reconstruction control module, and thus cooperatively calls a suitable service to complete a task, monitors an executing state of the task, and performs reconfiguration to the task execution in response to the change of the environment.

The resource discovery means this module manages an interface from a ubiquitous device node to an environment. Through a service registration and publishment mechanism, this module manages service information in a certain environment range (including the service provided by itself and the service discovered from the peripheral environment by itself, and a composite service charged by itself as a manager). Distributed nodes can cooperate with each other to implement organization of service resources in a whole ubiquitous environment, including organization in a dynamic situation (for example node joining or leaving), thus providing an effective discovery means of system service resources. Tools such as Extensible Markup Language (XML) and etc., are used. It focuses on regulation of a capability discovery mechanism, including information such as configuration, attribute, access, control way, interaction between devices through the network and etc., and introduces dynamic parsing and compiling function module into a semantic regulation of the resource discovery mechanism, thus ensuring plug and play of capability conforming to the self-description regulation; at the same time, the resource discovery is also in charge of judging whether multiple ubiquitous nodes are required to perform reconstruction and aggregation function according to the user service.

The aggregation control means forming a service aggregation orienting an optimum configuration (such as service quality, user satisfaction, and etc.) by discovering the service resource in the ubiquitous terminal network, making the service resource working cooperatively to implement an application requirement of the user in a ubiquitous terminal network environment. Implementation of an aggregation function will depend on interaction with the resource discovery, the configuration management, the service requirement processing and etc. The reconstruction control is closely related to the aggregation control, and is in charge of discovering a suitable substitute service and reconfiguring service composition to implement seamlessness in providing services and adaption to the environment when a service composition configuration is influenced by the dynamic environment (a service component disappears or a more suitable candidate component emerges). This module is implemented by cooperating with the configuration management, the resource discovery, the service requirement processing function.

A user peripheral network device performs aggregation and reconstruction for the ubiquitous terminal through virtual techniques, forms a virtual organization, and cooperatively provides service for the user, according to the service requirement and a context environment of the ubiquitous terminal and required terminal capability; The aggregation function includes discovery and aggregation, but it should be noted that a ubiquitous terminal environment has multiple convergence modes, such as master-slave, part, peer to peer, interworking, and etc.; with regard to a dynamic discovery frame and a mechanism design belonging to a control layer, a universal frame supporting multiple modes will be adopted, not only including a operating mode with or without a centre, but also supporting interaction methods such agent and forwarding, and a corresponding mechanism is intended to be introduced to support this function requirement (such as self-organization, self-government, layering, and clustering method). In aggregation and reconstruction, an optimization method orienting a user application requirement (user experience and Quality of Service (QoS)) should also be considered, for example, Design of an algorithm and a mechanism by using a distributed optimization decision-making method based on Teulon should take account of constraints of stability and robustness in implementation.

The context obtaining and processing is in charge of synchronously maintaining a universal state in a distributed environment, for example, a state of a aggregation service should be maintained cooperatively in a distributed device participating this service aggregation, the state is desired to maintain consistency and persistence when the service is transferred, this function has to be implemented through cooperative interaction of the configuration management with service requirement processing, reconstruction control, and etc., thus maintaining a synchronization universal state set in multiple ubiquitous devices and services; various information collection devices such as several sensors, Radio Frequency Identification (RFID) and etc., are contained in the ubiquitous device, this device and an input/detection type function, such as a keyboard input, network detection of the terminal, and etc., are uniformly abstracted as context obtaining resource, and storage, transformation, and processing of the same are implemented in a ubiquitous terminal system platform; advanced context information is obtained by using an inference mechanism, and is described in an ontology language.

The security privacy management means ensuring that the ubiquitous device and service are used in a proper way conforming to an intention of a system manager, a developer, a producer, and the user. Therefore, a security privacy management function is mainly in charge of configuring a service provided by the ubiquitous device in accordance with a certain strategy or process.

The distributed information processing takes charge of providing support of an executing environment for service transfer between nodes in an executing state, and also providing a life-cycle management function of a transferable service. It implements an operation and mechanism of movable services, such as transferring, copying, executing state synchronization, interaction, discovery and etc., through cooperating with the configuration management and resource discovery. According to the information obtained by interacting with the peripheral environment, such as intensity of a service resource requirement and etc., it is determined whether the service is to be transferred, copied and extincted, thus implementing optimized distribution and organization of the service resource in the environment.

The configuration management takes charge of providing the interface configured by the user, so that the user may configure a unified virtual terminal formed through aggregation and reconstruction in accordance with the user's preference. For example, in a certain scene, the user needs to unify the technique or service universally used by the virtual terminal to achieve a specific requirement thereof. In addition, the configuration management also supports operation on a unified virtual terminal device, a service and user information.

The multiple-interface enabling function means enabling inputs and outputs of multiple service streams simultaneously due to services provided by multiple ubiquitous network terminals cooperatively to the user; the involved inputs and outputs of the service streams include information interaction between ubiquitous terminals or information interaction between the terminals and the network.

The data processing layer includes two parts, namely data processing for directly providing service to the user and the data processing for cooperation of multiple terminals and sub-network capability.

The data processing for providing service to the user includes: data sharing, service engine, shunting, dynamic adaption, parsing and management.

The data processing for cooperation of multiple terminals and multiple sub-networks includes data aggregation and reconstruction, information collection, convergence, storage, parsing and management.

The resource access layer means access to network resources, where in a ubiquitous network architecture, the network resources include but are not limited to: terminal or device information, service information, and ratio resource information in a network layer; terminal or device information, and service information in a perception extension layer.

Subject matter of the technical scheme of the disclosure is further illustrated through a specific application embodiment below.

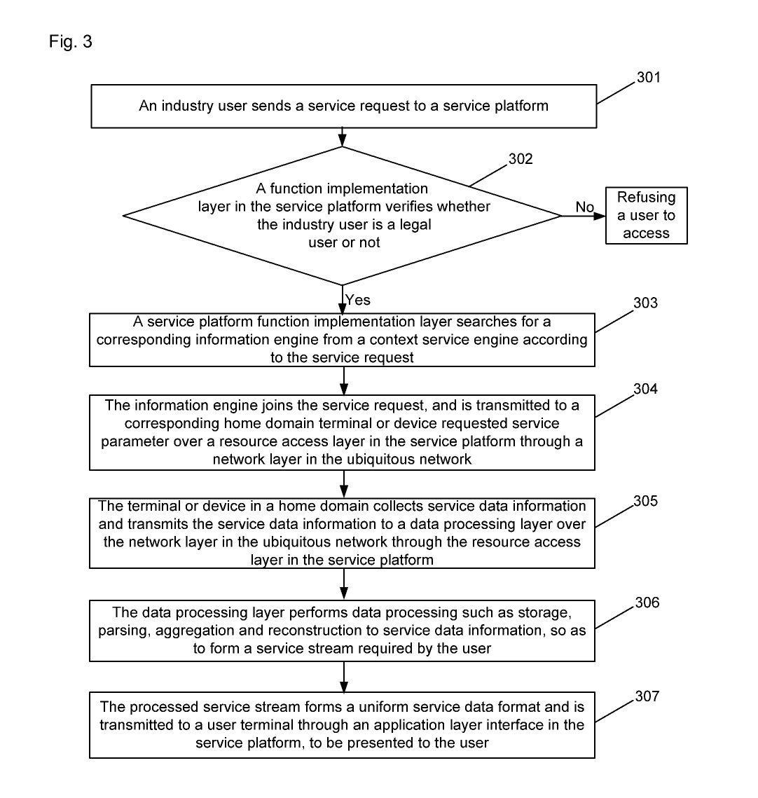

FIG. 3 is a flowchart of a service implementation method in the ubiquitous-network-based service platform according to an embodiment of the disclosure. As shown in FIG. 3, this embodiment is explained by taking an example in which a dynamically adapted industry application is directly provided for the user. The service implementation method in the ubiquitous-network-based service platform according to the embodiment of the disclosure includes the following steps:

Step 301, an industry user sends a service request to a service platform.

An industry application user sends a service request with respect to a certain home through a user terminal or device, for example, a doctor in a hospital checks physical condition of an aged man in a certain home; where the service request includes information of the doctor, such as the name of the doctor sending the request, a registered identification number, a verification code, and etc., and information of the aged man, such as a domain address of the home, the name of the aged man, the environment and physical condition, and etc.; the information of the doctor and information of a home domain and the aged man have been pre-stored in a service platform data processing layer.

Specifically, the service request is transmitted to the service platform in a unified service application interface format through a certain communication way.

Step 302, a function implementation layer in the service platform verifies whether the industry user is a legal user or not.

The function implementation layer in the service platform verifies whether the user performing the request is an authorized legal user or not through service authentication; if not, then directly refuses his/her access; if yes, directly executes Step 303.

Step 303, the function implementation layer in the service platform searches for a corresponding information engine from a context service engine according to the service request.

The service platform searches through the context service engine for an information engine related to the physical condition of the aged man in the home; where the information engine may include one or more information engines, for example, a house environment engine, such as a temperature and a humidity in the home where the aged man is located, a physical condition parameter engine, such as a blood pressure of the aged man, and other engine.

Step 304, the information engine joins the service request, and is transmitted to a corresponding home domain terminal or device requested service parameter over a resource access layer in the service platform through a network layer of the ubiquitous network.

According to the searched out information engine, a required service type is obtained, this service type is added into service request information of the service request user, this service request passes through the resource access layer in service platform in an event trigger way, and transmits service request information to the device or terminal in a corresponding home domain in the service request information via the same or different network devices in a network layer of the ubiquitous network.

Step 305, the terminal or device in the home domain collects service data information and transmits the service data information to the data processing layer over the network layer of the ubiquitous network through the resource access layer in the service platform.

The device or terminal in the home domain collects a corresponding service reference according to a user service request, and transmits the user service request to the service platform via the same or different network devices in the network layer of the ubiquitous network through the resource access layer in the service platform.

Step 306, the data processing layer performs data processing such as storage, parsing, aggregation and reconstruction and etc. to service data information, so as to form a service stream required by the user.

The service platform performs aggregation and reconstruction of service data through data processing, including data storage and parsing, according to the user's requirement.

Step 307, the processed service streams form a uniform service data format and are transmitted to a user terminal through a application layer interface in the service platform, to be presented to the user.

The processed service streams form the service streams required by the user, the service streams are further transformed through data processing, and are transmitted to the user terminal through uniform service application interface format data, to be presented to the user.

It should be explained that, all processes implemented in the above steps can be implemented through the above service platform. Because the service platform of the disclosure is described in more detail, the detail of each step is not repeated here.

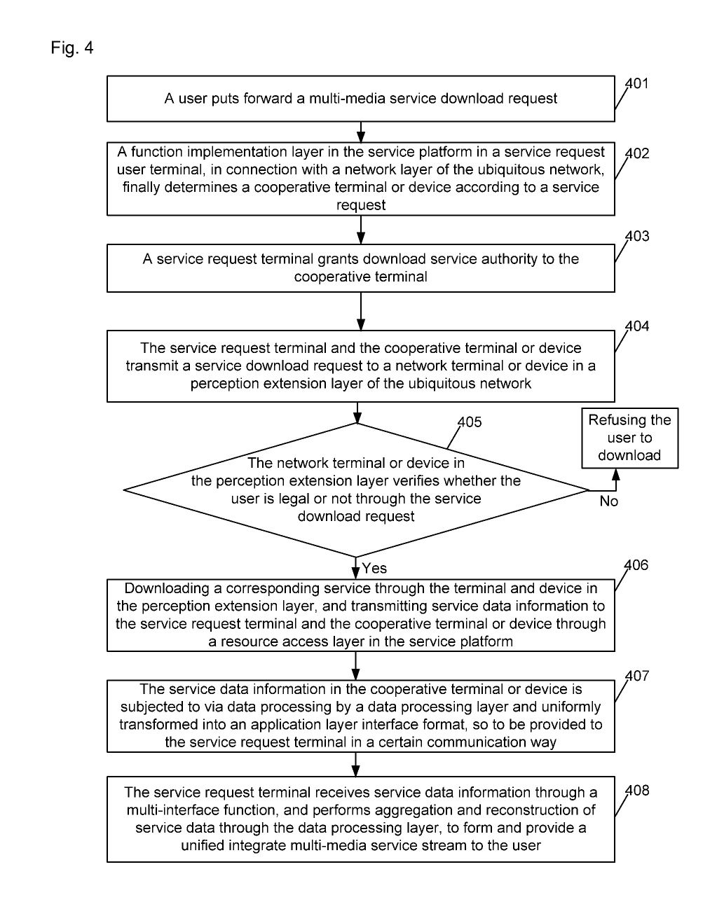

FIG. 4 is a flowchart of a service implementation method in ubiquitous-network-based service platform according to an embodiment of the disclosure. As shown in FIG. 4, in this embodiment, multiple terminals and sub-networks capability cooperatively provide service download for the user in a ubiquitous network environment, and the service implementation method in ubiquitous-network-based service platform according to this embodiment includes the following steps:

Step 401, a user puts forward a multi-media service download request.

The user puts forward a download service request through a user terminal, for example, the user in Working Domain 1 requests to download a multi-media service stream; the user terminal supports a service platform architecture; the service request includes information for authorizing the user such as user's name, registration information, and etc. and at the same time also includes but is not limited to service information such as a service type of the downloaded multi-media service stream.

Step 402, a function implementation layer in a service platform in a service requesting user terminal finally determines, in connection with the network layer of the ubiquitous network, a cooperative terminal or device according to the service request.

The user terminal performs resource discovery to a user peripheral environment through a function implementation layer in the service platform and through network resources of the ubiquitous network according to the service request, and at the same time collects user preference and context information through service requirement processing in the service platform.

Step 403, the service requesting terminal granted a service download authority to the cooperative terminal.

The determined cooperative terminal or device performs bidirectional authentication with the service requesting user through security privacy authentication function in the service platform; it is determined that the cooperative terminal or device has security, and at the same time allows the user terminal requesting the service to perform cooperative request and information transmission; where the service request terminal and the determined cooperation terminal or device support the service platform.

Step 404, the service requesting terminal and the cooperative terminal or device transmit a service download request to a network terminal or device in perception extension layer of the ubiquitous network.

The discovered and authenticated cooperative terminal or device, is finally determined as the cooperative terminal or device in the user periphery environment via a configuration management function in the service platform.

Each discovered cooperative terminal or device has a service download authority, by requesting the service requesting user terminal to grant.

The service requesting user terminal and other cooperative terminal or device put forward and transmit a service download request to a network terminal or device in the perception extension layer through a resource access layer in the service platform; the service download request includes a terminal type, terminal user authentication identification information, a service type, and etc.

Step 405, the network terminal or device in the perception extension layer verifies whether the user is legal or not through the service download request.

After receiving the service download request, the network terminal or device in the perception extension layer performs user identification and authentication to determine whether the user is legal or not, if not, refuses the user to download; otherwise executes Step 406, allowing the user to perform service download.

Step 406, a corresponding service is downloaded through the terminal and device in the perception extension layer, and service data information is transmitted to the service requesting terminal and the cooperative terminal or device through a resource access layer in the service platform.

Step 407, the service data information in the cooperative terminal or device is uniformly transformed to an application layer interface format through data processing by a data processing layer, so as to be provided to the service requesting terminal in a certain communication way.

Step 408, the service requesting terminal receives service data information through a multiple-interface function, and performs aggregation and reconstruction of service data through the data processing layer, to form and provide a unified integrated multimedia service stream to the user.

After the service requesting terminal and cooperative terminal or device perform corresponding service download through the network terminal or device in the perception extension layer, the downloaded service is transmitted to the service platform of the terminal or device through the service platform resource access layer.

The service downloaded by the cooperative terminal or device is stored and parsed through the data processing layer in the service platform, and is transformed to a unified application layer interface format and at the same time is provided to the service requesting user terminal in a certain communication way; the user terminal uses the multiple-interface function in the function implementation layer of the service platform to implement simultaneous inputs of service streams; the service requesting user terminal performs aggregation and reconstruction to service data information received by itself and from other cooperative terminal or device through the function implementation layer in the terminal service platform, forms a completed multimedia service stream, and directly presents it to the user, or the data processing layer in the service platform performs service data storage for other user to download and use.

The disclosure provides an implementation method of a service platform in a ubiquitous environment, to provide universal capabilities and supports for ubiquitous network applications, and to provide an open interface, allowing an application to access and use network resources and capabilities. By shielding specific bottom layer network implementations for ubiquitous network applications, complexity of developing and deploying upper level ubiquitous network application is simplified and reduced. According to context information such as service requirement, user preference, network feature, and etc., aggregation and reconstruction of resource and capability, dynamic intelligent service discovery, adaption and aggregation are implemented, various application services meeting the user's personalized requirement are implemented. Data between databases in the service platform can be shared with each other to implement reciprocal access between systems supporting different databases. In a ubiquitous condition, the user may operate multiple databases, without concerning detail of them such as data mode matching, data format transformation, and a physical location of the database, each database can shield all physical and logical differences thereof. More important, totally transparent operation of any database resource can be implemented, emphasizing unification between a data sharing mechanism and openness and universality of the ubiquitous network. At the same time, through the service platform, multiple heterogeneous network terminals or devices can cooperatively operate to provide user services together, providing a more beneficial implementation condition for information interaction and cooperation between terminals or devices and aggregation and reconstruction of the service.

All those described above are only preferred embodiment of the disclosure, and are not used to limit protection scope of the disclosure.

### INDUSTRIAL APPLICABILITY

The disclosure provides a unified platform orienting heterogeneous network convergence and heterogeneous device access through the service platform, provides universal capabilities and supports for ubiquitous network applications, and provides open interfaces, allowing the service applications to access and use the network resources and capabilities. The disclosure implements aggregation and reconstruction of abstract resources and capabilities, dynamic intelligent service discovery, adaption and aggregation according to the context information such as service requirement, user preference, network feature, and etc., implements various application services meeting user's personalized requirement, at the same time creates a basis for supporting the ubiquitous service to implement terminal cooperation and sub-network capability cooperation.

What is claimed is:

1. A service platform for a ubiquitous network, comprising: an application layer interface, a function implementation layer, a data processing layer, and a resource access layer,
wherein the application layer interface is configured to provide universal capability and support for a service application, and to provide a unified open interface to perform dynamic adaptation according to a user's requirement for a service;
wherein the function implementation layer is configured to implement cooperative service download and to directly provide the service for the user;
wherein the data processing layer is configured to directly perform data processing on the service for the user and to perform data processing for multiple terminals to cooperatively perform the service download; and
wherein the resource access layer is configured to access network resources.

2. The service platform according to claim 1, wherein the function implementation layer implements at least one of the following functions for directly providing the service for the user: terminal management, capability engine, context service engine, service provision and adaption, service aggregation and reconstruction, and service authentication; and
wherein the function implementation layer implements at least one of the following functions for implementing the cooperative service download: initialization, service requirement processing, resource discovery, context obtaining and processing, aggregation and reconstruction control, an event notification element, security privacy management, configuration management, distributed information processing, information strategy library, and multi-interface enabling.

3. The service platform according to claim 1, wherein the data processing layer directly performs at least one of the following data processings on the service for the user: data sharing, service engine, shunting, dynamic adaptation, parsing and management; and
wherein the data processing layer directly performs at least one of the following data processings for multiple terminals to cooperatively perform the service download: data aggregation and reconstruction, information collection, convergence, storage, parsing and management.

4. The service platform according to claim 1, wherein the resource access layer accesses at least one of the following network resources: resources in a network layer, terminal devices in a perception extension layer and sub-network capability resources.

5. The service platform according to claim 1, wherein the network resources comprises:
at least one of the following resource information in the network layer of the ubiquitous network: terminal or device information, service information, and radio resource information; and
at least one of the following resource information in the perception extension layer: terminal or device information, and service information.

6. A service implementation method in a ubiquitous-network based service platform, comprising:
when the service platform receives a service request, performing terminal management, capability engine, context service engine, service provision and adaption, service aggregation and reconstruction, so as to provide an application service meeting a user's personalized requirement for the user.

7. The method according to claim 6, wherein the terminal management comprises:
performing unified management on ubiquitous network devices,
performing local maintenance and remote management on the ubiquitous network devices and a network composed of the ubiquitous network devices, and
supporting user remote self-service management and update services.

8. The method according to claim 6, wherein the capability engine comprises:
abstracting the ubiquitous network devices as specific capabilities or resources,
abstracting service environments that can be provided by heterogeneous networks as the specific capabilities,
describing the capabilities in a universal mathematical description language, and
providing support for service adaption and personalized services.

9. The method according to claim 6, wherein the context service engine comprises:
dynamically obtaining context information of device capability, network feature, user preference and service content from a terminal side, a network side, a user side, an application side by means of context perception, and
storing and processing the context information under a predefined rule.

10. The method according to claim 6, wherein the service provision and adaption comprises:
implementing dynamic intelligent service discovery, service selection, service aggregation and service adaption function, according to obtained context information,
uniformly detecting and collecting the ubiquitous network, heterogeneous network environment and terminal environment state,
tracking and feeding back changes of a user service environment in real time,
performing service negotiation and adaption, and
dynamically cooperating the capabilities of the network and devices to guarantee a ubiquitous service quality, according to a service adaption result.

11. The method according to claim 6, wherein the service aggregation and reconstruction comprises:
adapting and combining service streams or sub-services from different heterogeneous networks to form user-required service provision, and
reconstructing a service process to provide an optimal service configuration process to the user.

12. The service platform according to claim 2, wherein the network resources comprises:
at least one of the following resource information in the network layer of the ubiquitous network: terminal or device information, service information, and radio resource information; and
at least one of the following resource information in the perception extension layer: terminal or device information, and service information.

13. The service platform according to claim 3, wherein the network resources comprises:
at least one of the following resource information in the network layer of the ubiquitous network: terminal or device information, service information, and radio resource information; and
at least one of the following resource information in the perception extension layer: terminal or device information, and service information.

14. The service platform according to claim 4, wherein the network resources comprises:
at least one of the following resource information in the network layer of the ubiquitous network: terminal or device information, service information, and radio resource information; and
at least one of the following resource information in the perception extension layer: terminal or device information, and service information.
